(19) United States
(12) Patent Application Publication
(10) Pub. No.: US 2024/0201460 A1
(43) Pub. Date: Jun. 20, 2024

(54) Optical Slip Ring

(71) Applicant: Overair, Inc., Santa Ana, CA (US)

(72) Inventor: Sean Rieb, Temecula, CA (US)

(21) Appl. No.: 18/287,433

(22) PCT Filed: Apr. 19, 2022
(86) PCT No.: PCT/US22/25284

§ 371 Date: Oct. 18, 2023

Related U.S. Application Data
(60) Provisional application No. 63/178,373, filed on Apr. 22, 2021.

(51) Int. Cl. G02B 6/43; B64D 47/02; G02B 6/42; H04B 10/25

(52) U.S. Cl. CPC G02B 6/43; B64D 47/02; G02B 6/4206; H04B 10/25

(57) ABSTRACT

In one aspect, disclosed herein is a simple, robust, and redundant slip ring for transferring electrical signals over a rotary joint. One embodiment comprises light guides configured to blend light from multiple light emitters and guide the blended light towards an array of light receivers—the slip ring is configured to transfer data across the rotating joint even when a receiver or emitter has failed.

### PRIORITY CLAIM

This application claims priority to U.S. provisional application having Ser. No. 63/178,373 (filed Apr. 22, 2021). These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is data transfer.

### BACKGROUND

Many systems require data transfer across a rotating joint. For example, a tethered submarine system might need to transfer data from a ship—across a winch spool—to the submarine side tether. A helicopter equipped with a hub side individual blade control actuation system is another example of a system requiring data transfer across a rotating joint; signals are sent between the helicopter's fuselage and the rotating portion of the rotor hub for the purpose of controlling important actuators.

Transferring data between two rotating frames has conventionally been accomplished by either a mechanical slip ring—that uses brushes to transfer data between two slip ring portions that are rotating relative to each other—or by fiber optic slip rings.

### SUMMARY

Data transfer using slip rings has traditionally fallen into two broad categories: brushed mechanical slip rings for power or data; or optical slip rings. Traditionally, most optical slip rings were configured for use with fiber optic data cable and leave much to be desired—especially with regards to robustness.

In one aspect, disclosed herein is a simple, robust, and redundant slip ring for transferring electrical signals between two rotating components. One embodiment comprises light guides that are configured to blend light from multiple light emitters and guide the blended light towards an array of light receivers. In one embodiment, the slip ring is configured to transfer data across the rotating joint at full capacity even when a receiver or emitter has failed.

### BRIEF DESCRIPTION OF THE DRAWINGS

FIG. 1 illustrates an isometric view of aspects an embodiment of a slip ring.

FIG. 2 illustrates a side view of an embodiment of a slip ring.

FIG. 3 illustrates a section view of the slip ring embodiment of FIG. 2.

FIG. 4 illustrates a block diagram of one implementation of an embodiment of a slip ring system.

FIG. 5 illustrates a side view of an alternative embodiment of a slip ring.

FIG. 6 illustrates a section view of the optical slip ring embodiment of FIG. 5.

FIG. 7 illustrates a section view of the slip ring embodiment as FIG. 5.

FIG. 8 depicts an aircraft comprising a slip ring.

FIG. 9 illustrates an embodiment of a slip ring circuit diagram.

FIG. 10 illustrates an embodiment of a slip ring corresponding to the circuit diagram of FIG. 9.

### DETAILED DESCRIPTION

Data transfer across slip rings has traditionally fallen into one of two broad categories: brushed mechanical slip rings that transfer power or data using brushes; or optical slip rings. Conventionally, most optical slip rings were configured for use with fiber optic data cables. Conventional optical slip rings leave much to be desired with regard to robustness.

In one aspect, disclosed herein is a simple, robust, and redundant slip ring for transferring information over a rotary joint. One embodiment comprises light guides configured to blend light from multiple light emitters and guide the blended light towards an array of light receivers. In one embodiment, the slip ring is configured to transfer data across the rotating joint at full bandwidth even when a receiver or emitter has failed.

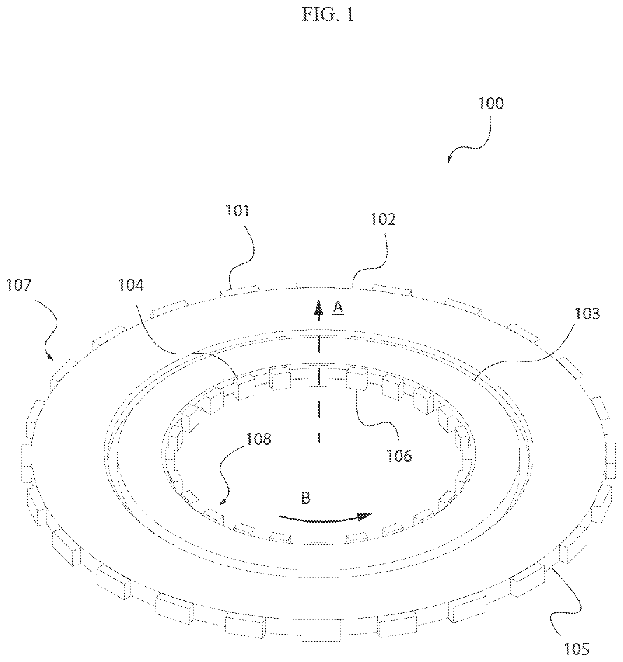

FIG. 1 illustrates one embodiment of an optical slip ring system 100. Optical slip ring system 100 comprises emitters 101, transmitter side light guide 102, receiver side light guide 103, and receivers 104. In the embodiment of FIG. 1, the emitters 101 comprise a light emitting diode. The emitters 101 and emitter side light guide 102 are fixed relative to a stationary reference frame, while the receiver 104 and the receiver side light guide 103 are in a rotating frame configured to rotate in the direction of rotation B.

An electrical signal is received by emitter 101; emitter 101 is triggered to emit light. The light travels through light guide 102 towards the array of light receivers 104. The light is internally reflected at the boundaries of emitter side light guide 102 at shallow angles of incidence. Thus, a large fraction of the light emitted from emitter 101 will travel towards the ring of receivers 104. One benefit can be a relatively high achievable system energy efficiency since the light guide results in low light loss through the sides of the light guide.

The embodiment of FIG. 1 comprises twenty-four emitters 101 and twenty-four receivers 104. The emitters and receivers in each optical set are all configured to use the same nominal light frequency. The light from the emitters 101 is spread out and blended such that every receiver 104 receives the common light signal emitted by emitters 101—at any azimuthal angle. Furthermore, in the in the embodiment of FIG. 1, if any one receiver 104 or emitter 101 fails, data is still transferred. Multiple light emitters contributing to a combined light signal that is received by multiple light receivers can result in desirable redundancy characteristics. In the embodiment of FIG. 1, the light guides 102 and 103 are interposed between the emitters 101 and receivers 104; the light guides contribute to the diffusion of light about the azimuth.

In the embodiment of FIG. 1, the slip ring does not rely on an unobstructed line of sight between any one pair of receivers and emitters at a set point in time. The plurality of receivers and emitters—in combination with the light guides—allows the slip ring to operate normally even at points in the slip ring rotor's cycle when there are obstructions between some of the emitters and some of the receivers. While some conventional slip rings that rely on uninterrupted line of sight between the receivers and emitters, the embodiment of FIG. 1 does not. This distinction can result in simpler, more robust, and more redundant slip rings. Furthermore, the slip ring of FIG. 1 may have advantageous package size and shape advantages over conventional slip rings.

In the embodiment of FIG. 1, the receivers are logically “OR'd” together such that if any one of the receivers 104 receive a signal from the corresponding emitter set, the signal will be passed along to the slip ring data output. The emitters are wired in parallel so that they are emitting the same signals. In other embodiments, the logic may require a certain minimum number of receivers to receive a signal before passing the signal along. Such logic could have desirable fault prevention characteristics.

Shown in FIG. 1 is emitter array 107 and receiver array 108. The emitter array 107 and receiver array 108 are both circular arrays and share a common center point. For example, as the slip ring rotor 106 rotates about the slip ring axis of rotation A, the receiver array 108 rotates inside of transmitter array 107; a ray from emitter 101 directed inward will intersect the circular receiver array 108.

The embodiment of FIG. 1 comprises a gap between emitter side light guide 102 and receiver side light guide 103. The light emitted from emitters 101 traverses the small air gap after passing through the emitter side light guide 102 and before entering the receiver side light guide 103. The light is guided by receiver side light guide 103 towards receivers 104.

In the embodiment of FIG. 1, the slip ring stator 105 comprises the light emitters 101 and the emitter side light guide 102. The slip ring rotor 106 comprises receivers 104 and light receiver side light guide 103.

In the embodiment of FIG. 1, emitter side light guide 102 and receiver side light guide 103 comprise plastic light pipes.

In other embodiments, the stator may comprise receivers or a combination of emitters and receivers. Likewise, the rotor can comprise emitters or emitters and receivers. In embodiments where the stator and rotor comprise both receivers and emitters, the receiver side light guide and emitter side light guide would simply be a rotor side light guide and a stator side like guide because both the rotor and stator would comprise a mixture of receivers and emitters.

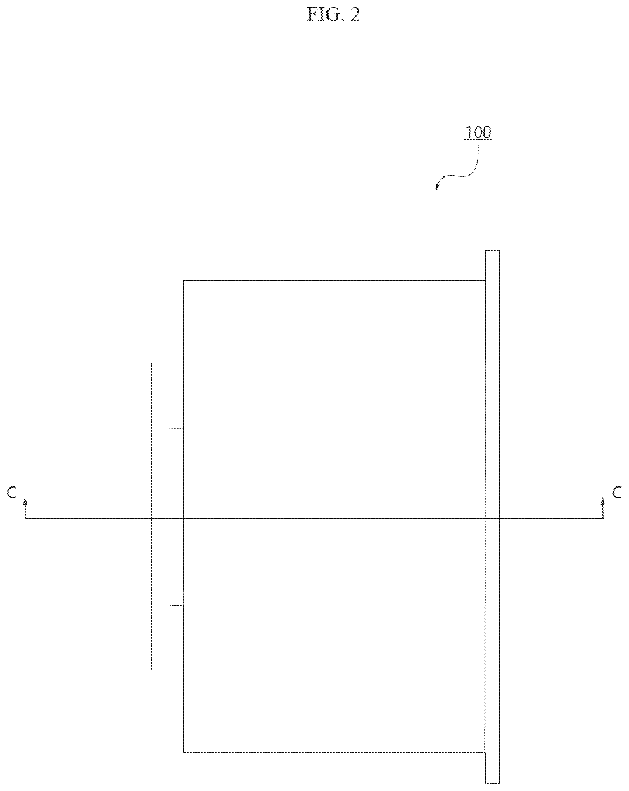

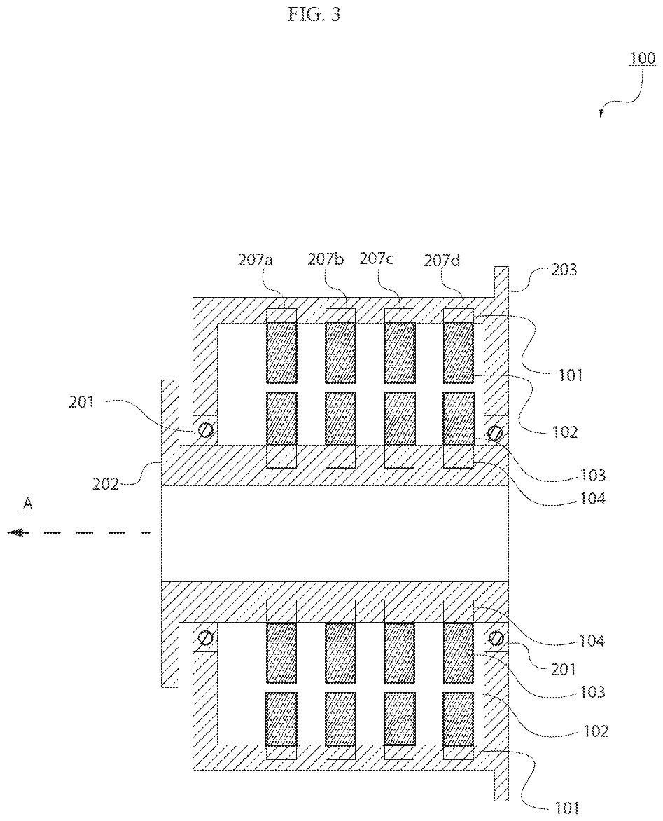

FIG. 2 illustrates a side view of an embodiment of a slip ring 100. Section line C-C is shown. A section view of C-C is shown in FIG. 3.

FIG. 3 illustrates a side view of an optical slip ring 100 comprising four optical sets 207a, 207b, 207c, and 207d. The optical sets can each comprise multiple communication channels or single communication channels. For example, optical set 207a can comprise a rotor side that comprises emitters configured for a first frequency of light and receivers configured for a second frequency of light. Optical set 207a can additionally comprise a stator side that comprises receivers configured for the first frequency of light and emitters configured for the second frequency of light. Since the first and second frequency of light are selected so as not to interfere with each other, the first optical set 207a can be configured for bi-directional communication. In the embodiment of FIG. 2, each optical set 207 additionally comprises a rotor side light guide and a stator side light guide.

In other embodiments, each optical set can be configured for any number of frequencies so long as the frequencies are not so similar to other frequencies such that they cause interference. Furthermore, each optical set can be configured for any portion of the channels to be rotor-to-stator channels or stator-to-rotor channels.

The embodiment of FIG. 3 comprises rotor shaft 202 and stator housing 203. Bearings 201 allow for relative motion of the rotor shaft and the stator housing. Rotor shaft 202 comprises recess grooves for receivers 104. Stator housing 203 comprises recess grooves for emitters 101.

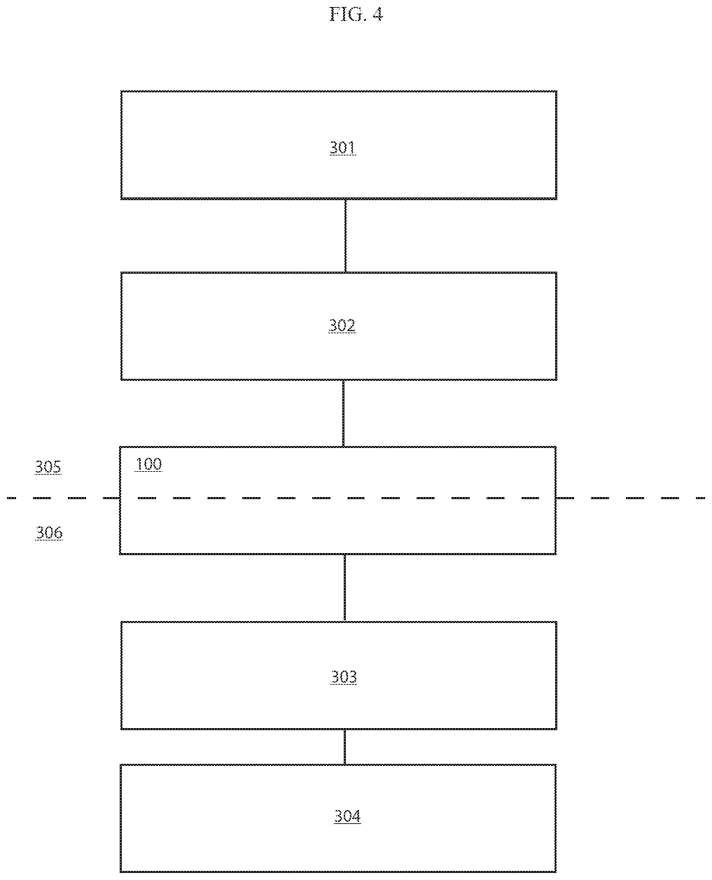

FIG. 4 illustrates a simplified diagram of one implementation of an embodiment of a slip ring system 100 in an aircraft individual blade control equipped aircraft. Flight control computer 301 sends a command to slip ring conditioning module 302. Slip ring conditioning module 302 processes the signal for transmission and sends the signals to slip ring system 100. The signal is transmitted from the stationary reference frame 305, across the slip ring system 100, to the rotating rotor hub frame 306. The signal is then sent to rotating side signal conditioning module 303, where it is processed and prepared for device 304. Device 304 can comprise any device that is desirable to send commands to, for example an individual blade control pitch actuator.

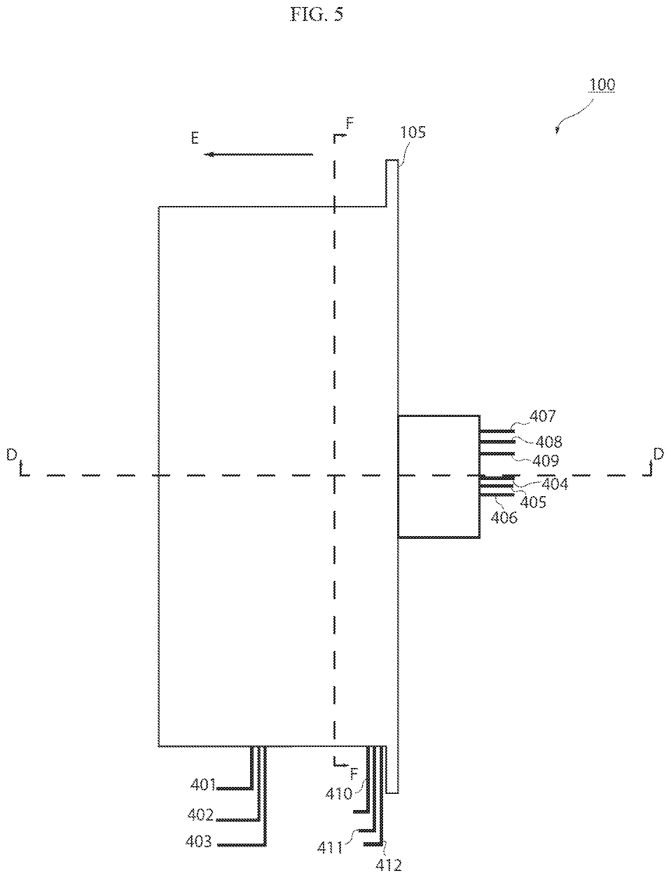

FIG. 5 illustrates a side view of an alternative embodiment of a slip ring 100. Section view lines F-F and D-D are shown.

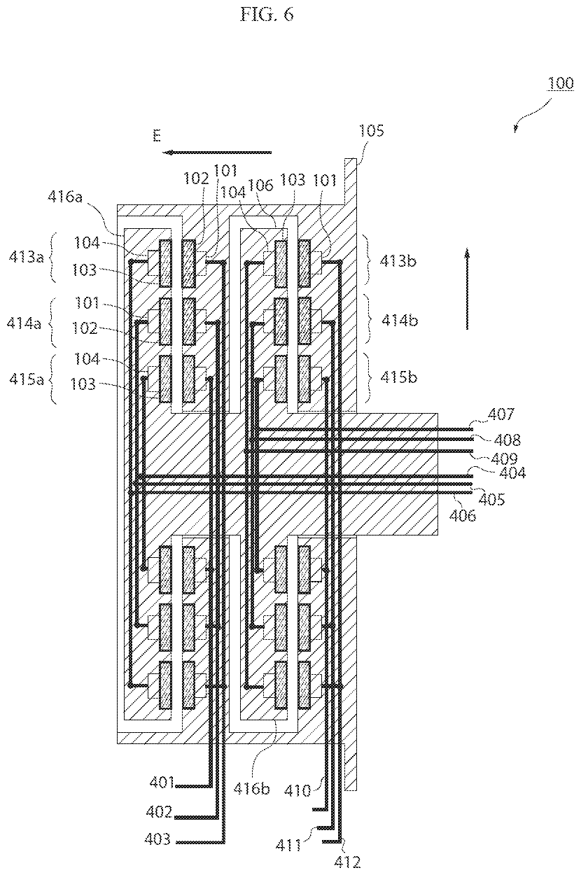

FIG. 6 illustrates an alternative embodiment of a slip ring system 100. The embodiment of FIG. 5 comprises coaxial receivers 104 and emitters 101. The slip ring system 100 comprises six optical sets 413a, 414a, 415a, 413b, 414b, and 415b. The embodiment comprises two rotor shaft discs 416a and 416b. Each optical set comprises an emitter array and a receiver array—the emitter array and receiver array that constitute a set are at the same radius and face each other parallel to the slip ring axis of rotation. The embodiment of FIG. 5 comprises a first group of optical sets configured for rotor to stator data transfer and a second group of optical sets configured for stator to rotor data transfer—thus the slip ring is configured for bi-directional data transfer. The embodiment of FIG. 4 may have packaging advantages for some applications.

The embodiment comprises two stacked groups of optical sets. Each of the two stacked groups comprise optical sets at three distinct radial stations 413, 414, and 415. The optical sets 413a, 414a, 415a, 413b, 414b, and, 415b can each comprise one or more uni-directional or bidirectional communication channels, so long as no one optical set is configured for two frequencies that interfere.

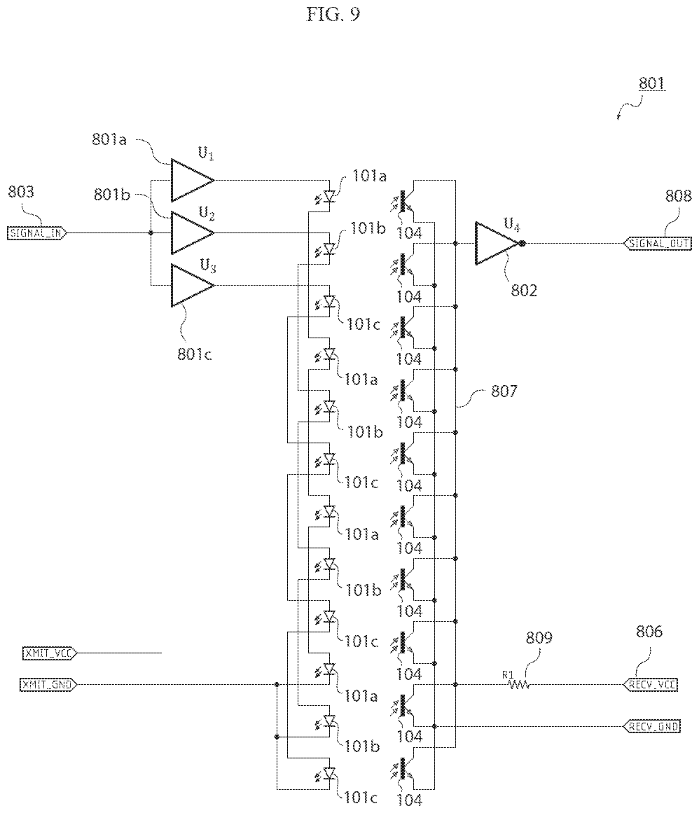

The embodiment of FIG. 6 comprises stator side stator-to-rotor signal wiring 401, 403, 410 and 412—attached at a first end to the respective LED driver 801—shown in FIG. 9—and at a second end to the respective emitter 101. Rotor side stator-to-rotor signal wires 404, 406, 407 and 409 are connected at first end to receivers 104 and at a second end to output signal bus 807—shown in FIG. 9.

Stator side rotor-to-stator signal wiring 402, 411—attached at a first end to the output signal bus 807 for the respective channel and at a first end to respective receivers 104. Rotor side rotor-to-stator signal wiring 405 and 408 are attached a first end to the respective LED driver 801 and at a second end to the respective emitters 101.

The embodiment of FIG. 6 comprises twice as many stator to rotor channels as rotor to stator channels; however, other embodiments may have any number or ratio of channels.

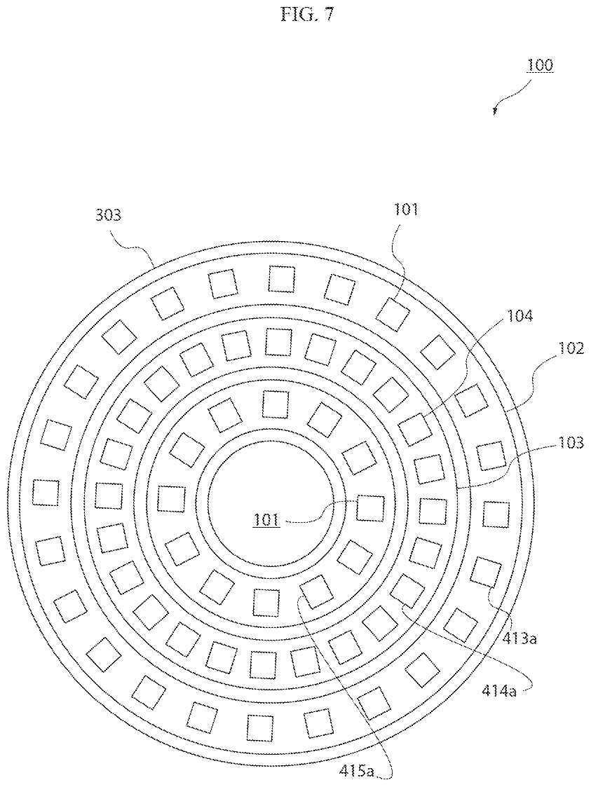

FIG. 7 illustrates section view F-F corresponding to section line F-F of FIG. 5. Three optical sets 413a, 414a, and 415a are shown.

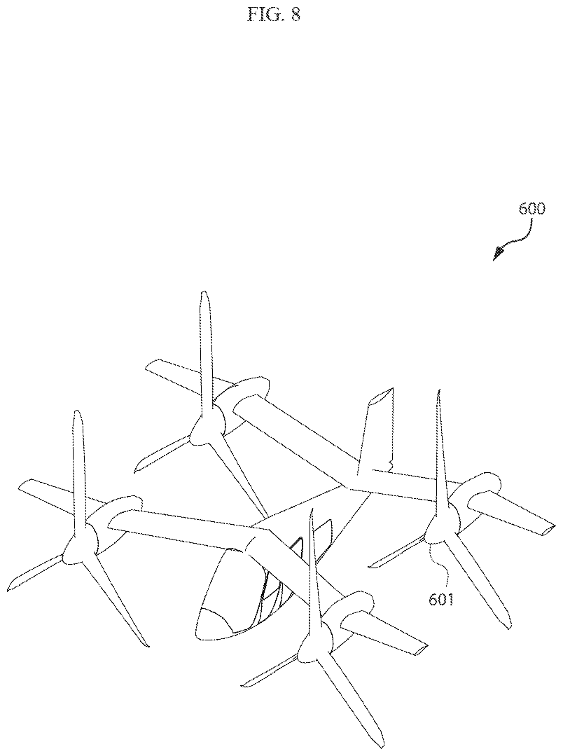

FIG. 8 illustrates aircraft 600 that comprises four slip rings. Each rotor system 601 comprises a slip ring system 100 for transmitting data between the airframe and the rotor hub.

FIG. 9 illustrates one embodiment of circuitry for an optical slip ring system 100. The input signal 803 is received by three led drivers 801 in parallel. Each led driver 801 drives a set of three LEDs 101. The three sets are interlaced about the axis of rotation. The drivers 801 are configured to command the same signal from the connected set of LEDs. The configuration provides redundancy so that if any one LED 801 or LED driver 804 fails, the slip ring system 100 will continue to transfer data at the normal data transfer rate.

Receivers 104 are all connected in parallel to supply side voltage 806. Any one of the receivers 104 can draw down the voltage. In the embodiment of FIG. 9, the receivers are normally open phototransistors. If any one of the receivers 104 receives a signal from emitters 101, the voltage on bus 807 will be drawn down, thus triggering output buffer 802. The output buffer 802 conditions the signal, including inverting the signal, thus generating output signal 808.

The receivers 104—in the embodiment of FIG. 9—comprise phototransistors. The receivers have an open failure mode. The receivers 104 are thus redundant because if one receiver 104 fails, the operational receivers 104 can still signal the output buffer 802 to generate a signal by dropping the voltage on bus 807.

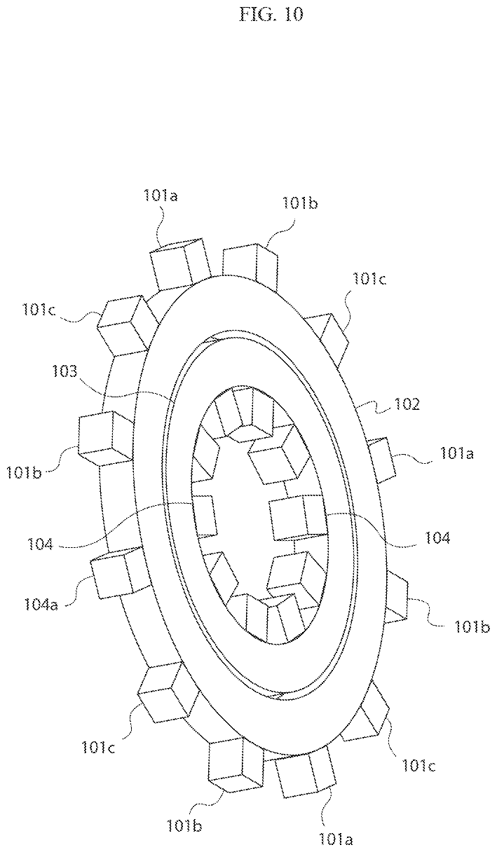

FIG. 10 shows aspects of the mechanical layout of the same embodiment of FIG. 9. The embodiment of FIG. 10 illustrates three sets of LEDs 101.

It should be recognized that the LED drivers 801, output buffer 802, and other supporting electronics can be remote to the main slip ring hardware.

In some embodiments, the slip ring comprises a faraday cage to protect the slip ring and/or a conductive interference and susceptibility isolation between the stator circuit and the rotor circuit.

In an alternative embodiment, the light guide may comprise any suitable light guide including a silvered cavity or a light pipe.

In alternative embodiments, light guides may comprise any suitable known light guide material including plastic or glass—including sectioned glass.

Light in the range between infrared to ultraviolet is especially preferred for embodiments described herein. However, some embodiments can use other frequencies of electromagnetic waves—for example microwave spectrum electromagnetic waves. However, in embodiments configured for microwave spectrum waves, the receivers could comprise antennas and the cavity could be very large. The light guides would be replaced by wave guides—for example four-inch cross section metallic cavities.

Emitters may comprise any suitable electromagnetic emitters including: LED lights or other semi-conductor emitter; or incandescent lights. LEDs are especially preferred because LED's are relatively rugged to vibration.

Receivers may comprise any suitable receiver including: phototransistor; photodiode, light activated silicon-controlled rectifier, or photoresistors.

While some embodiments herein are configured for use with light, it should be understood by one having ordinary skill in the art that other embodiments may be configured for use with any electromagnetic signal—for example radio frequency waves.

Especially preferred embodiments are configured for transferring digital data, however alternative embodiments could be configured for analog data transfer.

One embodiment of slip ring system 100 is configured for use with electrical signals on both the input side of the slip ring and on the output side of the slip ring. Some applications can use slip rings with a relatively lower bandwidth compared to slip rings configured for optical fiber systems. Although it should be understood that some aspects described herein can be configured for optical fiber systems.

In an alternate embodiment, one or more of the light guides may comprise light pipes comprising features along one or more edges that help diffuse or focus light. For example, in an alternative variation of the embodiment of FIG. 1, receiver side light guide 101 can comprise a slight convex surface along the inside side of the light pipe that helps focus the light on receiver 104.

It should be apparent to one skilled in the art that nominal signal frequencies may vary slightly, for example due to system error or system characteristics.

It should be understood that emitters and receivers of the same channel may use a spectrum of frequencies so long as the frequencies are capable of triggering the receivers of the respective channel.

It should be noted that any language directed to a flight control computer or the like should be read to include any suitable combination of computing devices, including servers, interfaces, systems, databases, agents, peers, engines, controllers, or other types of computing devices operating individually or collectively. The computing devices may comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed above with respect to the disclosed apparatus. In some embodiments, various servers, systems, databases, or interfaces may exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

1. A slip ring for transferring information across a rotary joint comprising a first and second light emitter and a first and second light receiver configured to transfer information using the same nominal frequency of light, wherein the first and second light emitter are configured to rotate relative to the first and second light receiver.

2. The slip ring of claim 1 wherein the slip ring is configured to transfer information even if one of the light emitters or light receivers is inoperable.

3. The slip ring of claim 2 wherein the light emitters are arranged in a first circular array and the light receivers are arranged in a second circular array and the first and second array share a center-point.

4. The slip ring of claim 3 wherein the first circular array and the second circular array are co-planar.

5. The slip ring of claim 2 additionally comprising a first light guide interposed between the first light emitter and the first light receiver.

6. The slip ring of claim 5 additionally comprising a second light guide interposed between the first light emitter and the first light receiver.

7. The slip ring of claim 6 wherein one of the light guides is configured to diffuse the light from the first light emitter.

8. The slip ring of claim 6 wherein one of the light guides is configured to combine the light from the first and second light emitter.

9. The slip ring of claim 5 wherein the light guide is configured to blend the light from the first and second light emitter so that each light receiver can receive a usable light signal at any slip ring azimuthal angle.

10. The slip ring of claim 9 wherein the first emitter and the first receiver are aligned along the axis of rotation.

11. The slip ring of claim 9 comprising diffusers on either the receiver side light guide or the emitter side light guide.

12. The slip ring of claim 1 additionally comprising third and fourth emitter and a third and fourth receiver and wherein the first and second receivers and emitters are arranged in first set and the third and fourth receivers and emitters are arranged in a second set.

13. The slip ring of claim 1 additionally comprising at least two light guides wherein at least one of the light guides comprises a focus feature along the side of the light guide directed towards the second light guide.

14. The slip ring of claim 1 additionally comprising a faraday cage configured to protect the slip ring.

15. The slip ring of claim 1 configured for a second data communication path.

16. The slip ring of claim 1 additionally comprising conductive interference and susceptibility isolation between a stator circuit and a rotor circuit.

17. The slip ring of claim 1 wherein the first light emitter and the first light receiver overlap a common radius and face each other.

18. An aircraft comprising a slip ring comprising a first and second light emitter and a first and second light receiver that transfer information using the same nominal frequency of light.

19. The aircraft of claim 18 wherein the slip ring is configured to transfer information even if any single light emitter or light receiver is inoperable.

20. The aircraft of claim 19 wherein the light emitters are arranged in a first circular array and the light receivers are arranged in a second array and the first and second array share a common center-point.

21. A slip ring comprising five light emitters and five light receivers configured to transfer information using the same nominal frequency of light.

22. The slip ring of claim 21 wherein the slip ring is configured to transfer information even if one of the light emitters or light receivers is inoperable.
